(19) United States
(12) Patent Application Publication
(10) Pub. No.: US 2024/0044225 A1
(43) Pub. Date: Feb. 8, 2024

(54) SYSTEMS AND METHODS FOR PRODUCING HYDROCARBON MATERIAL FROM OR INJECTING FLUID INTO A SUBTERRANEAN FORMATION USING A PRESSURE COMPENSATING VALVE ASSEMBLY

(71) Applicant: NCS MULTISTAGE INC., Calgary (CA)

(72) Inventor: Tim JOHNSON, Alberta (CA)

(21) Appl. No.: 18/256,085

(22) PCT Filed: Nov. 30, 2021
(86) PCT No.: PCT/CA2021/051709

§ 371 Date: Jun. 6, 2023

Related U.S. Application Data
(60) Provisional application No. 63/122,098, filed on Dec. 7, 2020.

(51) Int. Cl. E21B 34/14; E21B 17/02; F15B 1/26; F15B 15/20

(52) U.S. Cl. CPC E21B 34/14; E21B 17/028; F15B 1/265; F15B 15/20; E21B 2200/06

(57) ABSTRACT

A valve assembly for disposition within a subterranean reservoir is provided. The valve assembly includes a valve housing defining a fluid passage, and a housing outlet for establishing fluid communication between the fluid passage and the reservoir. The valve assembly further includes a valve sleeve displaceable between closed and open positions for controlling fluid communication between the fluid passage and the reservoir. The valve assembly also includes a hydraulic actuator operable to displace the valve sleeve, the hydraulic actuator including a hydraulic fluid container and a pump. A pressure-compensating system is operatively connected to the hydraulic actuator, and includes a tubing-pressure compensator configured to adjust a fluid pressure within the fluid passage relative to a fluid pressure of the hydraulic fluid container; and a reservoir-pressure compensator configured to adjust a fluid pressure of the reservoir surrounding the valve assembly relative to a fluid pressure of the hydraulic fluid container.

### RELATED APPLICATIONS

This application claims the benefit of and priority to U.S. Patent Application No. 63/122,098, entitled “SYSTEMS AND METHODS FOR PRODUCING HYDROCARBON MATERIAL FROM OR INJECTING FLUID INTO A SUBTERRANEAN FORMATION USING A PRESSURE COMPENSATING VALVE ASSEMBLY” and filed on Dec. 7, 2020. The content of the aforementioned application is incorporated herein by reference in its entirety.

### TECHNICAL FIELD

The present disclosure relates to apparatuses, systems and methods for producing hydrocarbon material from a subterranean formation using a drive process.

### BACKGROUND

Drive or displacement processes produce hydrocarbon material from a subterranean formation by injecting a pressurized fluid from an injection well into subterranean formation such that hydrocarbon material within a subterranean formation is driven to a production well. In some instances, there is channeling of the injected fluid through the subterranean formation. The channeling results in the injected fluid bypassing the hydrocarbon material contained within the subterranean formation.

Moreover, space limitations within wellbores affect the volumetric rate of fluid (e.g. injected frac fluid, produced hydrocarbons, etc.) that is flowable between the surface and a hydrocarbon-containing reservoir. These space limitations are exacerbated by downhole tools which are deployed within the wellbore. To increase the amount of space that is available to enable flowing of fluids within the wellbore, it is desirable to configure downhole tools so as not to unnecessarily occupy this valuable space.

### SUMMARY

According to a first aspect, there is provided a valve assembly for disposition within a subterranean reservoir. The valve assembly includes a valve housing having a tubular wall defining a fluid passage and a housing outlet extending through the tubular wall for establishing fluid communication between the fluid passage and the reservoir. The valve assembly also has a valve sleeve displaceable between closed and open positions, for controlling the fluid communication between the fluid passage and the reservoir, and a hydraulic actuator operable to displace the valve sleeve. The hydraulic actuator includes a hydraulic fluid container for containing hydraulic fluid; and a pump operatively connected to the hydraulic fluid container. The valve assembly further includes a pressure-compensating system operatively connected to the hydraulic actuator, and which includes a tubing-pressure compensator fluidly connected to the hydraulic actuator and the fluid passage, the tubing-pressure compensator being configured to adjust a fluid pressure within the fluid passage relative to a fluid pressure of the hydraulic fluid container. The pressure-compensating system also includes a reservoir-pressure compensator fluidly connected to the hydraulic actuator and the reservoir, the reservoir-pressure compensator being configured to adjust a fluid pressure of the reservoir surrounding the valve assembly relative to a fluid pressure of the hydraulic fluid container.

According to a possible embodiment, the tubing-pressure compensator is in fluid communication with the reservoir-pressure compensator via the hydraulic fluid container, and wherein the tubing-pressure compensator and reservoir-pressure compensator are configured to cooperate to adjust the fluid pressure within the fluid passage and the fluid pressure within the reservoir relative to one another.

According to a possible embodiment, the tubing-pressure compensator comprises a first piston having a first end in fluid communication with the fluid passage, and a second end in fluid communication with the hydraulic fluid container, and wherein the reservoir-pressure compensator comprises a second piston having a first end in fluid communication with the reservoir, and a second end in fluid communication with the hydraulic fluid container.

According to a possible embodiment, the first and second pistons are configured to actuate autonomously to adjust the fluid pressures within at least one of the fluid passage and the reservoir.

According to a possible embodiment, the hydraulic fluid container comprises a first tubular container in fluid communication with the tubing-pressure compensator, and a second tubular container in fluid communication with the reservoir-pressure compensator, the first and second tubular containers being in fluid communication with each other.

According to a possible embodiment, the first tubular container and tubing-pressure compensator are axially aligned within the valve housing, and wherein the second tubular container and reservoir-pressure compensator are axially aligned within the valve housing.

According to a possible embodiment, the hydraulic container and the pump extend axially within the valve housing and are distributed around the fluid passage.

According to a possible embodiment, the valve sleeve is slidably mounted within the valve housing and slidable within the fluid passage between the open position for enabling fluid communication between the fluid passage and the reservoir, and the closed position for preventing fluid communication between the fluid passage and the reservoir.

According to a possible embodiment, the valve sleeve is slidable between the open and closed positions via actuation of the hydraulic actuator.

According to a possible embodiment, the valve sleeve is mounted within the fluid passage and defines one or more hydraulic chambers between an outer surface of the valve sleeve and an inner surface of the valve housing, the hydraulic chambers being adapted to be pressurized to create a force on the valve sleeve to displace the valve sleeve.

According to a possible embodiment, the hydraulic chambers are fluidly connectable to the hydraulic fluid container and adapted to receive hydraulic fluid from the hydraulic fluid container via the pump and respective hydraulic passages.

According to a possible embodiment, the valve assembly further includes a tubing-pressure sensor in fluid pressure communication with the fluid passage and configured to measure the fluid pressure within the fluid passage, and a reservoir-pressure sensor in fluid pressure communication with the reservoir configured to measure the fluid pressure within the reservoir surrounding the valve assembly.

According to a possible embodiment, the tubing-pressure sensor and reservoir-pressure sensor extend axially within the valve housing and are distributed around the fluid passage.

According to a possible embodiment, the tubing-pressure sensor and reservoir-pressure sensor are operatively connected to and communicate with a controller installed at surface.

According to a possible embodiment, the valve assembly further includes a control unit disposed within the valve housing and configured to operate the hydraulic actuator, the control unit comprising a connector for interfacing with a power and communications cable.

According to a possible embodiment, the control unit extends axially within the valve housing and is radially spaced from the fluid passage.

According to a possible embodiment, the valve assembly further includes a coupling assembly having a body removably secured to the housing and being adapted for coupling the power and communications cable to the control unit.

According to a possible embodiment, the coupling assembly comprises a lateral connector for receiving the power and communications cable, and a transversal connector extending from the lateral connector and being configured to splice the power and communications cable and provide a connection for interfacing with the connector of the control unit.

According to a possible embodiment, the valve housing comprises a recessed portion shaped and configured to receive the body of the coupling assembly, and wherein the coupling assembly is radially contained within an outer diameter of the valve housing.

According to a possible embodiment, the valve housing comprises a longitudinal passage extending axially along an outer surface of the valve housing and on either sides of the recessed portion, and wherein the lateral connector is adapted to axially align with the longitudinal passage such that the power and communications cable is radially contained within the outer diameter of the valve housing.

According to a possible embodiment, the body of the coupling assembly comprises an outer shell adapted to cover the lateral connector and configured to be secured to the valve housing.

According to a possible embodiment, the outer shell is secured to the valve housing via fasteners.

According to a possible embodiment, the valve assembly is operatively connectable to other valve assemblies deployed along the wellbore via the power and communications cable.

According to a possible embodiment, the valve housing comprises at least two valve housing sections connectable to one another, and wherein a first valve housing section comprises axially extending channels configured to house the tubing-pressure compensator, the reservoir-pressure compensator, the hydraulic fluid container and the pump.

According to a possible embodiment, the axially extending channels are defined in a thickness of the tubular wall and are distributed around the fluid passage.

According to a possible embodiment, connecting a second valve housing section to the first valve housing section encloses the axially extending channels.

According to a possible embodiment, the valve sleeve is shaped and adapted to be mechanically shifted between the open and closed positions using a shifting tool adapted to engage an inner surface of the valve sleeve

According to a second aspect, a valve assembly for disposition within a subterranean reservoir is provided. The valve assembly includes a valve housing comprising a tubular wall defining a fluid passage and having a housing outlet extending through the tubular wall for establishing fluid communication between the fluid passage and the reservoir. The valve assembly also includes a valve sleeve displaceable between closed and open positions, for controlling the fluid communication between the fluid passage and the reservoir, and a hydraulic actuator operable to displace the valve sleeve. The hydraulic actuator includes a hydraulic fluid container for containing hydraulic fluid; and a pump operatively connected to the hydraulic fluid container. The valve assembly further has a pressure-compensating system operatively connected to the hydraulic actuator and being configured to provide a bi-directional pressure compensation for adjusting fluid pressure within at least one of the valve assembly and the reservoir surrounding the valve assembly.

According to a possible embodiment, the pressure-compensating system enables injection operations where fluids are injected into the reservoir via the housing outlet, and production operations where fluids are produced from the reservoir via the housing outlet.

According to a third aspect, there is provided a hydrocarbon producing system, which includes an injection well having an injection wellbore string comprising one or more valve assembly as defined above configured to selectively establish fluid communication between the injection wellbore string and the reservoir to inject an injection fluid in the reservoir; and a production well having a production wellbore string comprising one or more valve assembly as defined above configured to selectively establish fluid communication between the production wellbore string and the reservoir to receive production fluid from the reservoir comprising hydrocarbons.

According to another aspect, there is provided a valve assembly for disposition within a subterranean reservoir. The valve assembly includes a housing comprising a tubular wall defining a fluid passage and having a housing outlet extending through the tubular wall for establishing fluid communication between the fluid passage and the reservoir; a valve sleeve displaceable between closed and open positions, for controlling the fluid communication between the fluid passage and the reservoir; a hydraulic actuator operable to displace the valve sleeve between the closed and open positions; a control unit disposed within the housing and configured to operate the hydraulic actuator, the control unit comprising a connector for interfacing with a power and communications cable; and a coupling assembly for coupling the power and communications cable to the control unit, the coupling assembly having a body removably secured to the housing. The coupling assembly has a lateral connector comprising first and second ends for receiving the power and communications cable therethrough; and a connector configured to splice the power and communications cable and provide a connection for interfacing with the control unit.

According to yet another aspect, there is provided a method of assembling a valve assembly for installation in a wellbore string comprising one or more valve assemblies already installed therein. The method includes providing a power and communications cable, said power and communications cable being operatively connected to the one or more valve assemblies already installed in the wellbore string; connecting the power and communications cable to a coupling assembly and splicing the power and communications cable to provide an electrical connection interface on the coupling assembly; connecting the electrical connection interface to a corresponding interface on the valve assembly to establish an electrical connection between the power and communications cable and a control unit in the valve assembly; and securing the coupling assembly to a housing of the valve assembly.

According to another aspect, there is provided a valve assembly for disposition within a hydrocarbon-containing reservoir. The valve assembly includes a housing comprising a tubular wall defining a central passage and having a housing outlet extending through the tubular wall for establishing fluid communication between the central passage and the reservoir; a valve sleeve operatively mounted within the housing and being displaceable within the central passage between at least one of a closed configuration for blocking the housing outlet, and an open configuration for allowing fluid communication between the central passage and the reservoir, the valve sleeve having an inner surface facing the central passage and an outer surface facing the tubular wall of the valve housing; a hydraulic actuator mounted within the housing, comprising a hydraulic fluid container containing hydraulic fluid; a pump operatively connected to the hydraulic fluid container, the hydraulic actuator being operatively connected to the valve sleeve and adapted to shift the valve sleeve within the housing between the closed and open configurations using hydraulic fluid provided via the pump, the valve sleeve being further shaped and configured to be mechanically shifted using a shifting tool adapted to engage the inner surface of the valve sleeve.

### BRIEF DESCRIPTION OF DRAWINGS

FIG. 1 is a schematic illustration of an implementation of a well system including a pair of wells extending into a subterranean reservoir, according to an implementation;

FIG. 2 is a transverse cut view of a portion of the well system according to an implementation, showing a valve assembly installed within a casing string;

FIG. 3 is a perspective view of the valve assembly shown in FIG. 2;

FIGS. 4 and 5 are sectional view of the valve assembly shown in FIG. 3, illustrated in a first configuration (FIG. 4) and a second configuration (Figure FIGS. 4A and 5A are enlarged views of FIGS. 4 and 5, respectively;

FIG. 6 is a perspective view of the valve assembly shown in FIG. 3, showing a hydraulic actuator disposed within a valve housing, according to an implementation;

FIGS. 7 and 8 are perspective views of the valve assembly showing hydraulic fluid inlets communicating with a valve sleeve disposed in a closed position, according to an implementation;

FIG. 9 is a perspective view of the valve assembly, showing the valve sleeve disposed in the open configuration and one of the hydraulic fluid inlets being in fluid communication with a hydraulic chamber, according to an implementation;

FIG. 10 is a perspective view of the valve assembly, showing a pressure-compensating system disposed in the housing of the valve assembly according to an implementation;

FIG. 11 is a block diagram of the pressure-compensating according to a possible implementation, showing a tubing-pressure compensator and a reservoir-pressure compensator;

FIG. 12 is a perspective view of a portion of the valve assembly shown in FIG. 10, showing a pair of pressure sensors installed within the valve housing, according to an implementation;

FIG. 13 is a side view of the valve assembly shown in FIG. 3, showing a coupling assembly connected to a control unit disposed within the housing, according to an implementation.

FIG. 14 is a sectional view of the coupling assembly shown in FIG. 13, showing a lateral connector extending generally parallel to the housing, and a connector extending from the lateral connector and into the housing, according to an implementation.

FIG. 15 is a partially exploded view of the valve assembly shown in FIG. 3, showing the coupling assembly shaped and sized to be inserted in a corresponding recessed portion of the valve housing, according to an implementation.

FIG. 16 is a schematic illustration of a portion of a wellbore string, showing a plurality of valve assemblies connected to one another via conduits and a power and communications cable, according to an implementation.

FIG. 17 is an exploded view of the valve assembly according to an implementation, showing a plurality of valve housing sections connectable to one another to form the valve assembly.

### DETAILED DESCRIPTION

As will be explained below in relation to various implementations, the present disclosure describes apparatuses, systems and methods for various operations, such as the recovery of hydrocarbon material from a subterranean formation having a subterranean reservoir. Broadly described, the present disclosure describes a remotely controlled valve assembly, for downhole deployment within a wellbore extending into the subterranean reservoir. The valve assembly is shaped, sized and adapted to be integrated as part of a wellbore string and is configured to be remotely operable between various configurations for allowing fluid(s) to be injected within the reservoir, and fluid(s) to be produced from the reservoir via the same wellbore string. In exemplary implementations, the valve assembly is operable to inject fluid (e.g., a fluid for stimulating hydrocarbon production via a drive process, such as waterflooding, or via a cyclic process, such as “huff and puff”) into the subterranean formation, and to produce reservoir fluids containing hydrocarbons. In other words, the valve assembly can be configured to allow both injection and production operations within the reservoir. The valve assembly can be operated using various forms of fluid, such as, for example, liquids, gases, or mixtures of liquids and gases.

As will be described further below, the valve assembly, and corresponding structural features, can be operated for the injection and/or recovery of fluids via the wellbore. The valve assembly can be provided with a pressure-compensating system configured to adjust the pressures within and around the valve assembly depending on the application of the valve assembly (e.g., production or injection). The valve assembly can further be provided with a control unit configured to communicate with various operational components of the valve assembly to enable remotely switching the valve assembly from a closed configuration to an open configuration and enable fluid communication with the surrounding reservoir. In addition, the valve assembly can include hydraulic components operatively coupled to the control unit for operating the valve assembly, but can also include mechanical components as a redundancy to the hydraulic components, for example.

It is noted that the completion system and the valve assemblies can be implemented in various wellbores, formations, and applications including hydrocarbon recovery and geothermal applications. In some implementations, the wellbore can be straight, curved, or branched, and can have various wellbore sections. A wellbore section should be considered to be an axial length of a wellbore. A wellbore section can be characterized as “vertical” or “horizontal” even though the actual axial orientation can vary from true vertical or true horizontal, or can tend to undulate or corkscrew or otherwise vary. The term “horizontal”, when used to describe a wellbore section, refers to a horizontal or highly deviated wellbore section as understood in the art, such as a wellbore section having a longitudinal axis that is between 70 and 110 degrees from vertical. For simplicity, it is noted that most of the conduits, channels, passageways, pipes, tubes and/or other similar components referred to in the present disclosure have a cross-section that is preferably circular or annular, although it should be appreciated that other shapes are also possible.

In some implementations, reservoir fluids are recovered from the reservoir by initially injecting a fluid (which can be referred to as a mobilizing fluid or an injection fluid) within the reservoir via a plurality of valve assemblies of a first well (e.g., injection well). In some applications, the injection fluid is adapted to mobilize hydrocarbons contained in the reservoir and drive the hydrocarbons towards a second well (e.g., production well) similarly provided with a plurality of valve assemblies adapted for fluid production for recovery of the hydrocarbons. In hydrocarbon recovery operations, the valve assemblies of the production well are adapted for receiving fluid that can include mobilized hydrocarbons from the reservoir and for producing the mobilized hydrocarbons to ultimately recover the hydrocarbons at surface.

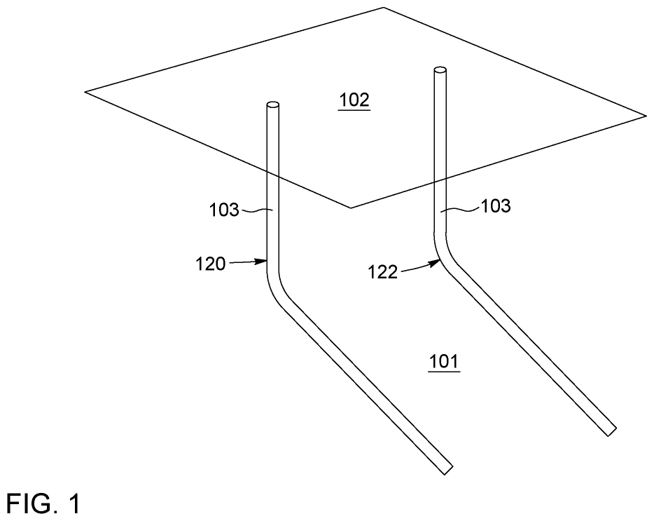

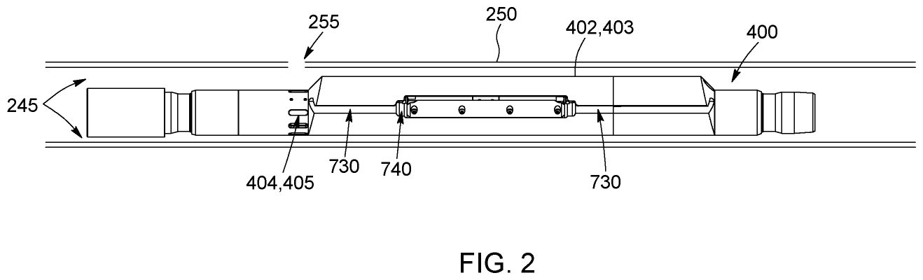

With reference to FIGS. 1 and 2, a well system can include an injection well 120 and a production well 122, illustrated in FIG. 1, which extend from the surface 102 and into a wellbore 103 in a subterranean reservoir 101. In some implementations, for example, hydrocarbon production can be carried out via the well system, and, in this respect, to carry out the displacement process, fluid (e.g. water) is injected via the injection well 120, resulting in displacement of hydrocarbon material from the reservoir 101 and into the production well 120, and flow of the displaced hydrocarbon material to the surface 102 is carried out via the production well 120.

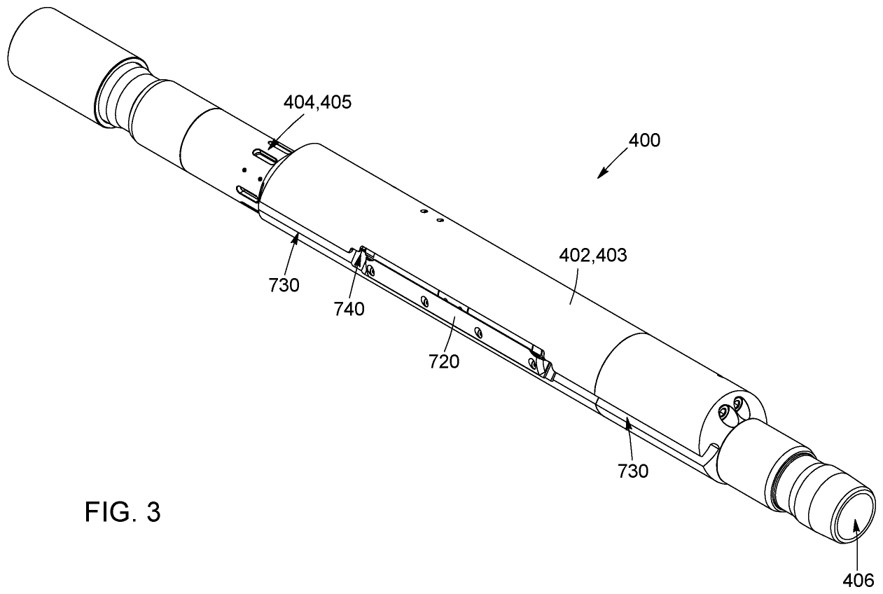

In the present implementation, one or more valve assemblies 400 can be integrated as part of a wellbore string extending within the wellbore 103. The wellbore string defines a wellbore string passage for conducting fluid between the surface 102 and the reservoir 101. More specifically, and as will be described below, the valve assemblies 400 can be provided with one or more ports at respective locations along the wellbore for establishing fluid communication between the wellbore string and the reservoir. With reference to FIG. 3, in addition to FIGS. 1 and 2, the valve assembly 400 includes a housing 402 having a tubular wall 403 defining a central passage 406 for enabling fluid communication through the housing 402. In other words, the central passage can act as a fluid passage 406 configured to allow a flow of fluid therethrough and along the wellbore string. The valve housing 402 has an uphole end and a downhole end adapted to be connected between lengths of conduits in order to integrate the valve assembly within the wellbore string. It is noted that the conduits are not illustrated in the figures, but would be located on either end of the valve assembly 400 and can be coupled to respective ends of the valve housing 402 by various methods. As previously described, the valve assembly 400 can be adapted to be integrated into the wellbore string, and, in this respect, the fluid passage 406 forms part of the wellbore string passage.

The housing 402 also defines a housing outlet 404, through which fluid communication between the passage 406 and an environment external to the housing 402 (e.g., the reservoir 101) is established. In some implementations, the housing outlet 404 includes one or more ports 405 defined through the tubular wall 403 of the housing 402. The ports 405 can be formed as generally oblong openings through the valve housing 402, although other configurations are possible. In some implementations, each valve assembly 400 is configurable in a plurality of operational configurations, and each one of the operational configurations, independently, corresponds to a state of fluid communication, via the ports 405, between the passage 406 and the surrounding reservoir. In other words, fluid flow through the housing outlet 404 can be at least partially controlled via a change in the operational configuration of the valve assembly 400 (e.g., a change from a first operational configuration to a second operational configuration).

In this implementation, the valve assembly 400 can be operated in a first operational configuration, such as a closed configuration, where the ports 405 are occluded, therefore preventing fluid flow between the fluid passage 406 and the reservoir. In addition, the valve assembly 400 can be operated from the closed configuration to the second operational configuration, such as an open configuration, where one or more of the ports 405 is at least partially open, or fully open. It is appreciated that in the open configuration, the valve assembly 400 enables fluid to flow through the one or more injection ports 405 (e.g., into or from the reservoir).

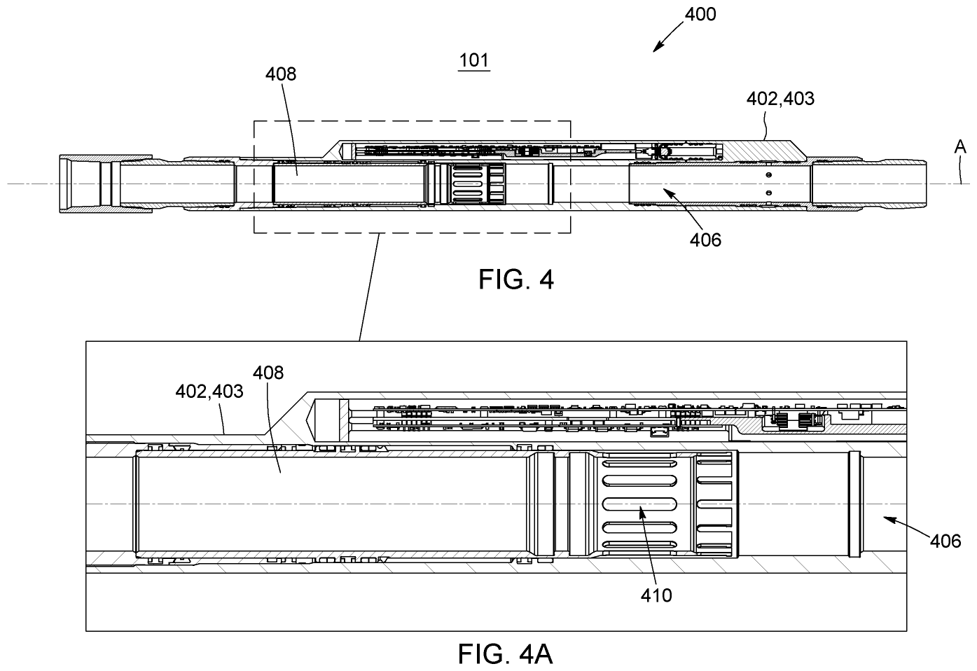

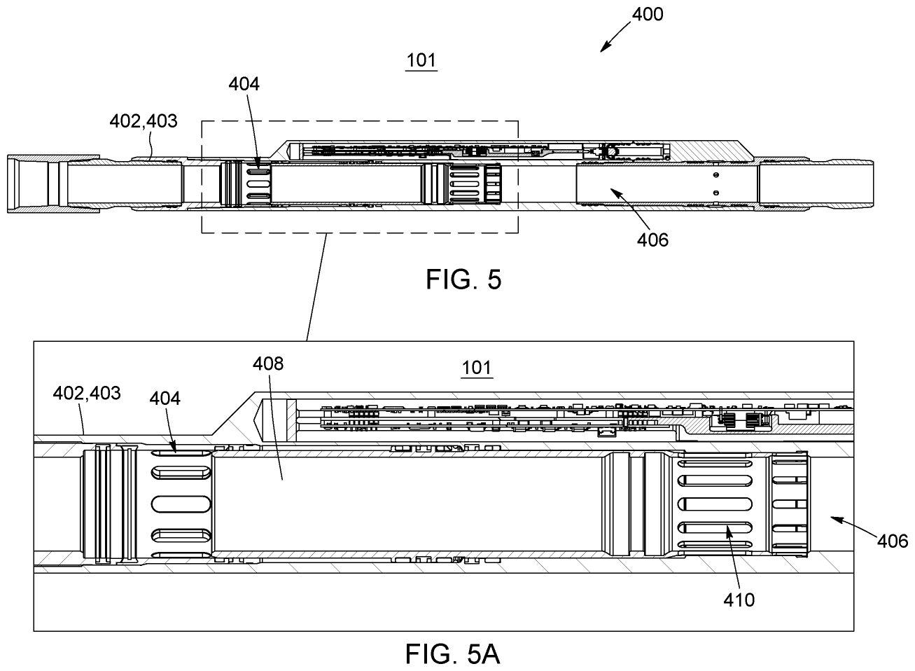

Now referring to FIGS. 4 to 5A, in addition to FIGS. 1 to 3, it is appreciated that the valve assembly 400 is configured for controlling fluid communication between the central passage 406 and the surrounding reservoir 101. In this implementation, the valve assembly 400 includes a valve sleeve 408 operatively mounted within the valve housing 402 for selectively closing and opening the housing outlet 404. The valve sleeve 408 can be slidably mounted within the housing 402 for moving axially therealong, e.g., along a longitudinal axis A (FIG. 4). It should thus be understood that the valve sleeve 408 is adapted to be displaced along the passage 406 in various positions in order to direct fluid flow into predetermined fluid pathways of the valve assembly 400. In this implementation, the valve sleeve 408 is displaceable between a closed position (seen in FIG. 4) and an open position (seen in FIG. 5). The open position corresponds to the open configuration of the valve assembly 400, while the closed position corresponds to the closed configuration of the valve assembly 400.

The valve sleeve 408 can be mounted within the housing 402 in a manner allowing the sleeve to slide, or shift, from one position to another. It should be understood that the expression “shift” can refer to the displacement of the valve sleeve 408 using a shifting tool, for example, or a self-shifting mechanism provided as part of the valve assembly. The valve sleeve 408 can be held in place within the valve housing 402 using any suitable method or component, such as retaining rings (e.g., O-rings disposed about the valve sleeves), shear pins, a piston actuated mechanism or a combination thereof, for example.

In this implementation, the closed position of the valve sleeve 408 corresponds to an alignment of a portion of the valve sleeve 408 with the housing outlet 404 to occlude the housing outlet 404, thus preventing fluid flow into the reservoir. As described above, the open configuration of the valve assembly 400 can be achieved by moving the valve sleeve 408 along the passage 406 so as to no longer occlude the housing outlet 404. In some implementations, the valve sleeve 408 can include one or more sleeve outlets 410 adapted to be aligned with the housing outlet 404 to define a fluid flowpath between the fluid passage 406 and the reservoir 101. The housing 402 and the valve sleeve 408 can be cooperatively configured such that, while the sleeve outlets 410 are aligned with the housing outlet 404, fluid communication between the fluid passage 406 and the reservoir is established via the defined fluid flowpath. In some implementations, the fluid flowpath defined via the alignment of the sleeve outlets 410 has a predetermined resistance to material flow such that the flowrate of fluid through the housing outlet 404 is restricted. It is appreciated that the open configuration of the valve assembly 400 can be achieved by moving the valve sleeve 408 away from the housing outlet 404 so as to no longer occlude the outlet, or by aligning the sleeve outlets 410 with the housing outlet 404.

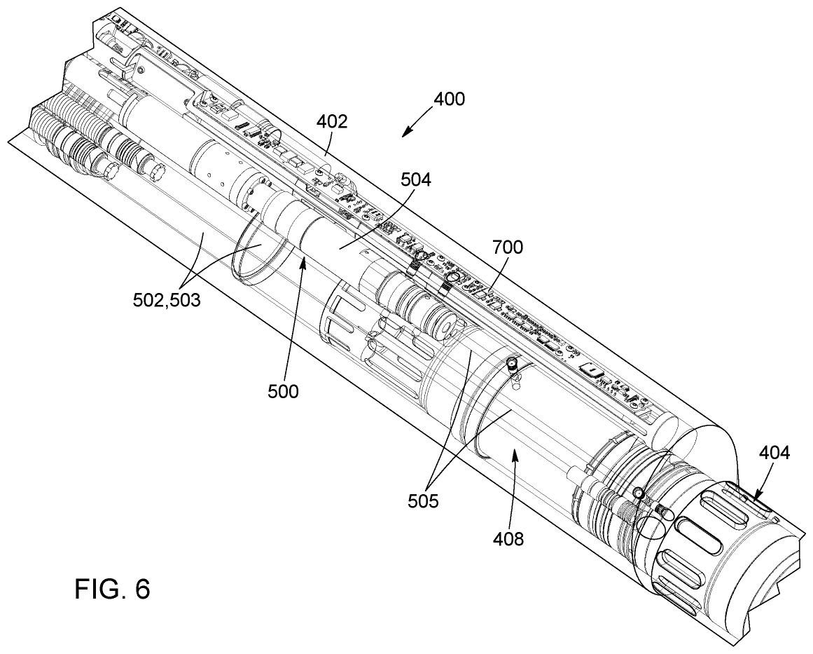

In this implementation, and with reference to FIG. 6, the valve assembly 400 further includes an actuator 500 configured to displace the valve sleeve 408 (e.g., between the closed and open positions). In some implementations, the valve sleeve 408 can be shaped and configured to be displaceable in response to receiving an actuation signal (e.g., via a hydraulic pump). In the present implementation, the actuator is a hydraulic actuator 500 operable to slide the valve sleeve 408 along the passage 406 within the housing 402, although other actuators, or types of actuators are possible and may be used. It should be understood that the hydraulic actuator 500 is configured to hydraulically actuate the valve sleeve 408 via the injection of a working fluid, or hydraulic fluid, at one or more locations in or about the valve assembly 400. With reference to FIGS. 6 to 9, the hydraulic actuator 500 includes a hydraulic fluid container 502 for containing the hydraulic fluid, and a pump 504 operatively connected to the hydraulic fluid container 502 and enabling the circulation of hydraulic fluid. In this implementation, the hydraulic fluid container 502 includes a pair of tubular containers 503 disposed side-by-side and in fluid communication with one another, although it is appreciated that other configurations are possible.

For installation down the wellbore, the hydraulic fluid container 502 and pump 504 can be connected to any suitable portion of the valve assembly 400. For example, and as illustrated in FIG. 6, the hydraulic actuator 500 (e.g., the hydraulic fluid container and the pump) can be installed within a thickness of the housing 402, with a plurality of hydraulic fluid passages 505 extending therefrom to various components of the valve assembly 400.

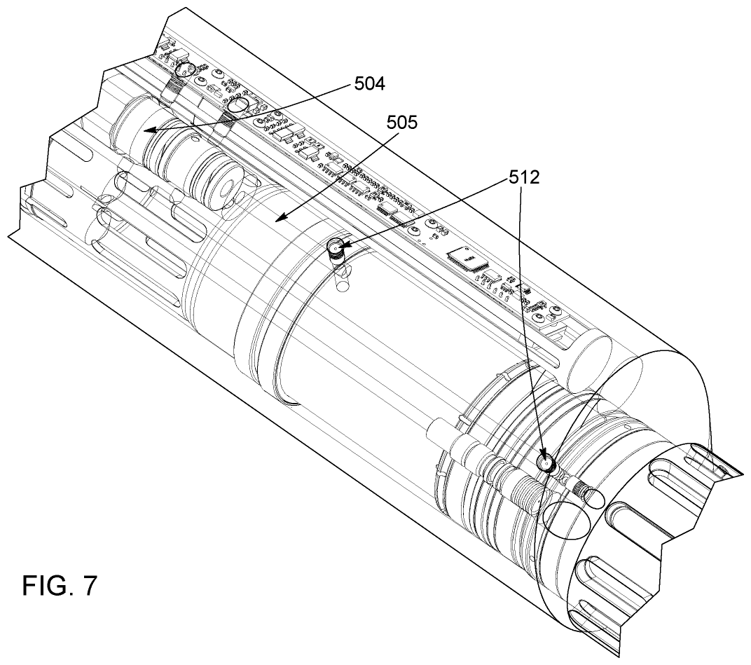

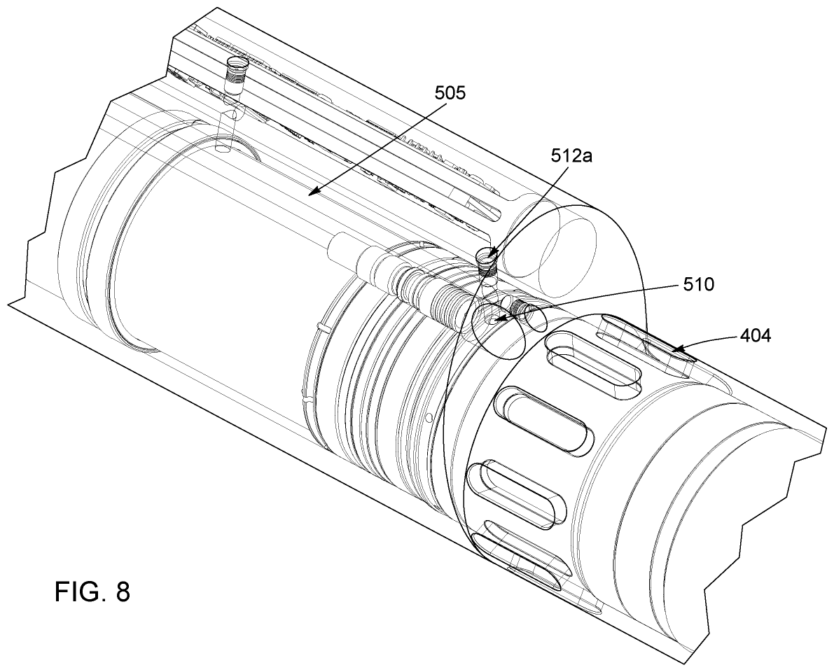

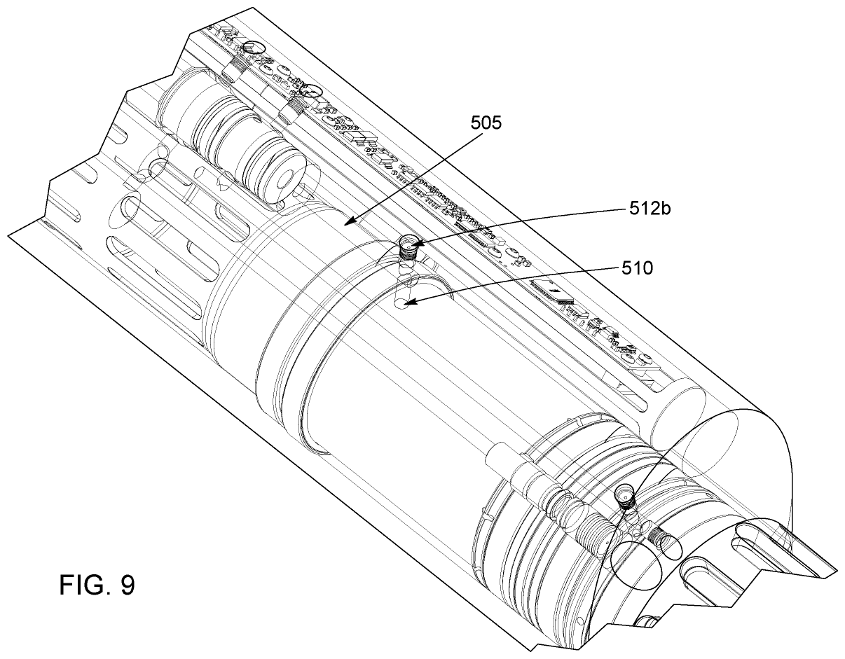

Referring more specifically to FIGS. 7 to 9, the hydraulic actuator 500 is in fluid pressure communication with the valve sleeve 408 in a manner such that providing hydraulic fluid to the valve sleeve 408 can displace the valve sleeve 408 between the open and closed positions. The housing 402, the hydraulic fluid and the valve sleeve 408 are co-operatively configured such that, in response to pressurizing of the hydraulic fluid, an unbalanced force is established and exerted on a section of the valve sleeve 408 for urging movement of the valve sleeve 408. In some implementations, the hydraulic actuator 500 has a first mode of operation and a second mode of operation, and, in the first mode of operation, the establishment of an unbalanced force shifts the valve sleeve in the open position (see FIGS. 5 and 9), and, in the second mode of operation, the establishment of an unbalanced force shifts the valve sleeve 408 in the closed position (see FIGS. 4 and 8).

In this implementation, the valve sleeve 408 is positioned within the housing 402 in a manner defining one or more hydraulic chambers 510 defined between an outer surface of the valve sleeve and an inner surface of the housing 402. Hydraulic fluid is routed, via the pump 504 and hydraulic passages 505, from the hydraulic fluid container to a hydraulic fluid inlet 512 in fluid pressure communication with the hydraulic chamber 510. In this implementation, while the valve sleeve 408 is in the closed position, a first hydraulic fluid inlet 512a is in fluid pressure communication with the hydraulic chamber 510 such that injecting hydraulic fluid in the hydraulic chamber 510 via the first inlet 512a effectively pressurizes the hydraulic chamber and establishes the unbalanced force to shift the valve sleeve from the closed position to the open position. Similarly, while the valve sleeve is in the open position, a second hydraulic fluid inlet 512b is in fluid pressure communication with the hydraulic chamber 510 such that injecting hydraulic fluid in the hydraulic chamber 510 via the second inlet 512b effectively pressurizes the hydraulic chamber and establishes the unbalanced force to shift the valve sleeve from the open position to the closed position.

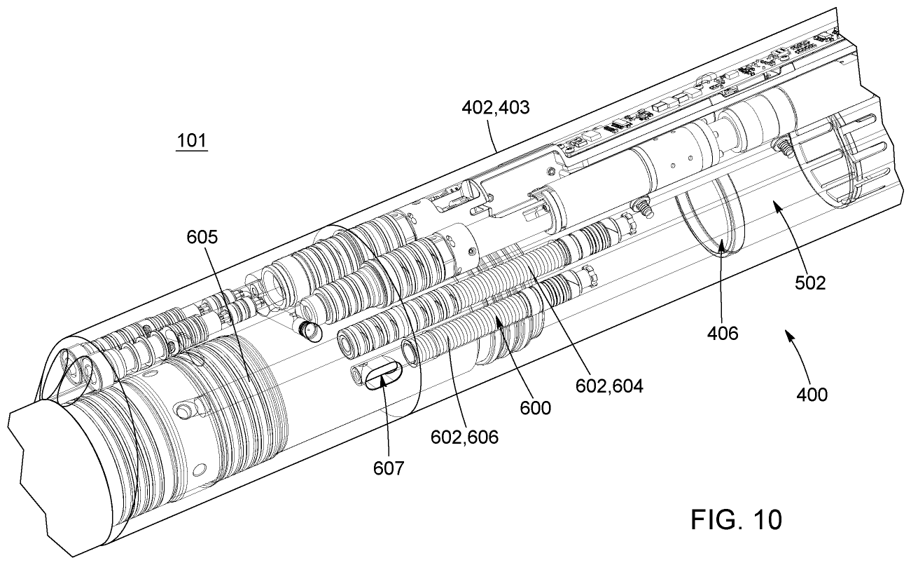

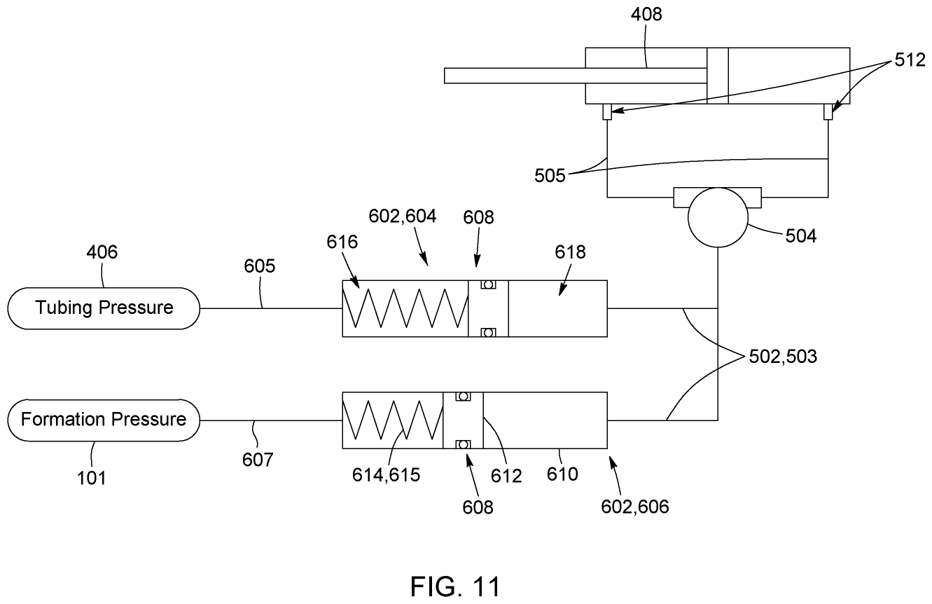

Now referring to FIGS. 10 and 11, in addition to previous Figures, in some implementations, the valve assembly includes a pressure-compensating system 600 adapted to create a pressure-balanced system between the valve assembly 400 and the surrounding reservoir 101. More specifically, the pressure-compensating system 600 can be configured to adjust the pressure of at least one of the fluid passage 406 of the valve housing 402 and the reservoir surrounding the valve assembly in order to stabilize the pressures with respect to one another. In this implementation, the pressure-compensating system 600 is operatively connected to the hydraulic actuator 500 such that hydraulic fluid can be routed to corresponding locations to balance the pressures, at least partially, between the fluid passage 406 and the surrounding reservoir 101.

In some implementations, the pressure-compensating system 600 can include one or more pressure compensators 602 in fluid communication with respective locations and adapted to regulate/adjust the pressure of these locations. The pressure compensators 602 are fluidly connected to the hydraulic fluid container 502 and respective locations to enable pressure regulation of those locations, for example via injection of hydraulic fluids. It is appreciated that having a single pressure compensator connected to one of the fluid passage and reservoir effectively enables a uni-directional pressure compensation of the wellbore proximate the valve assembly, whereas providing a pair of pressure compensators (as illustrated in FIG. 10) provides for a bi-directional pressure compensation of the wellbore. It should be noted that a bi-directional pressure compensation can enable use of the valve assembly 400 in both injection and production operations. For example, if the pressure is greater in the surrounding reservoir, injection operations are at least partially impeded, whereas if the pressures are adjusted to be relatively balanced, then injection operations can be performed, and vice-versa for production operations. In other words, both the injection well and production well can be respectively provided with the same valve assembly 400.

In the present implementation, the pressure compensators 602 include a tubing-pressure compensator 604 fluidly connected between the hydraulic actuator 500 and central passage 406, and a reservoir-pressure compensator 606 fluidly connected between the hydraulic actuator 500 and surrounding reservoir 101. As seen in FIGS. 10 and 11, the tubing-pressure compensator 604 is fluidly connected to the central passage 406 via one or more passages 605 extending between the compensator 604 and an opening defined in the housing 402 of the valve assembly 400. The reservoir-pressure compensator 606 is fluidly connected to the reservoir 101 via a passage 607 opening into the reservoir and communicating with the compensator 606, although other configurations are possible.

In some implementations, the pressure compensators (i.e., the tubing-pressure compensator and the reservoir-pressure compensator) can be configured to actuate when a pressure of fluid within the hydraulic container 502 is below a pressure of fluid in the corresponding location. More specifically, the tubing-pressure compensator 604 can be adapted to actuate when the fluid pressure in the hydraulic fluid container 502 is below the fluid pressure in the central passage 406. In a similar fashion, the reservoir-pressure compensator 606 can be adapted to actuate when the fluid pressure in the hydraulic fluid container is disposed below the fluid pressure in the surrounding reservoir 101. It should thus be appreciated that the pressure compensating system 600 can be configured to regulate the pressures autonomously and automatically upon detecting a pressure shift at one or more locations.

Referring more specifically to FIG. 11, a block diagram of the pressure compensating system 600 is illustrated. In this implementation, each pressure compensator 602 can have a similar structure to provide pressure compensation to the valve assembly and surrounding reservoir. The pressure compensators 602 can each include a compensator piston assembly 608 configured to actuate to at least partially regulate the pressures between the fluid passage 406 and the reservoir 101. In some implementations, the compensator piston assembly 608 can be substantially the same for the tubing-pressure compensator 604 and the reservoir-pressure compensator 606. As illustrated in FIG. 11, the compensator piston assembly 608 can include a piston cylinder 610 shaped and configured to contain a piston head 612 and a biasing element 614 therein. In this implementation, the biasing element 614 includes a spring 615 connected to the piston head 612 and being configured to maintain (i.e., bias) the piston head 612 in a predetermined position within the piston cylinder 610.

It is appreciated that the piston head 612 is adapted to slide within the piston cylinder 610 based on the pressure differential on either side of the piston head 612. More specifically, the piston head 612 defines a first fluid chamber 616 on a first side thereof, and a second fluid chamber 618 on a second side thereof. Thus, based on the pressure differential between the first and the second fluid chambers 616, 618, the piston head 612 is displaced within the piston cylinder 610. It should be understood that the piston head 612 will be displaced towards the fluid chamber having the lower fluid pressure between the first and second fluid chambers.

In other words, in this implementation, when fluid pressure within the valve assembly (e.g., in the fluid passage 406) is greater than the fluid pressure of the reservoir 101, the piston head 612 of the tubing-pressure compensator 604 correspondingly actuates (e.g., moves within the piston cylinder 610), which increases the fluid pressure within the hydraulic container 502. In the illustrated implementation of FIG. 11, the piston head 612 of the tubing-pressure compensator 604 moves to the right within the piston cylinder 610. Then, the fluid pressure within the hydraulic container 502 is transferred to the reservoir-pressure compensator 606 in order to ultimately increase fluid pressure of the reservoir 101 (i.e., the piston head 612 of the reservoir-pressure compensator 606 moves to the left in the illustrated block diagram of FIG. 11), and regulate the fluid pressures in and around the valve assembly 400.

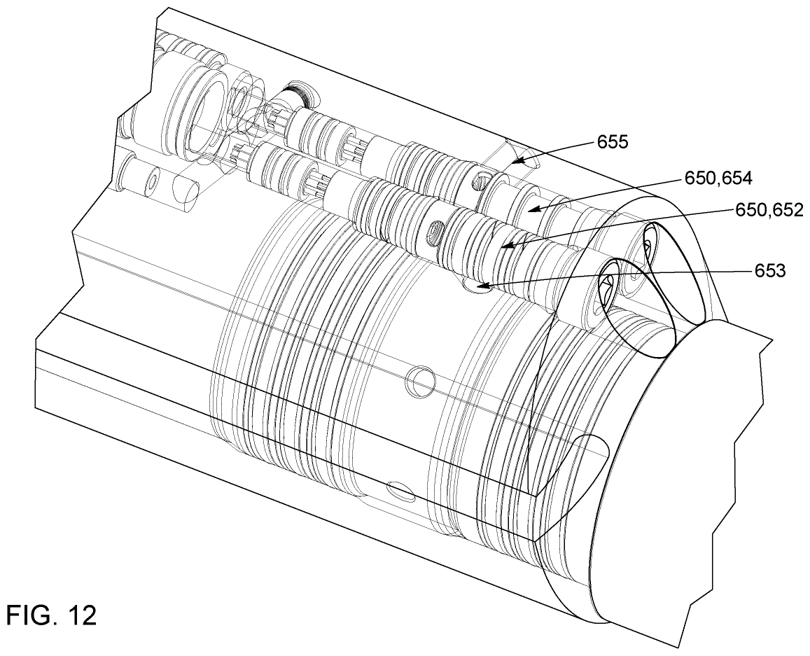

Now referring to FIG. 12, in some implementations, the valve assembly 400 can be provided with one or more sensors 650 configured to measure one or more parameters of the valve assembly 400 and surrounding reservoir 101. In this implementation, the sensors 650 include a tubing-pressure sensor 652 configured to measure tubing pressure within the valve housing (e.g., along the fluid passage 406). In addition, the sensors 650 can include a reservoir-pressure sensor 654 configured to measure a reservoir pressure in the reservoir 101 surrounding the valve assembly. As seen in FIG. 12, the tubing-pressure sensor 652 is in fluid pressure communication with the fluid passage via passage 653 opening into the fluid passage, whereas the reservoir-pressure sensor 654 is in fluid pressure communication with the reservoir via passage 655 opening into the reservoir. However, it is appreciated that other configurations are possible for connecting the pressure sensors to their respective environments.

The pressure sensors 650 can be configured to measure the pressure of respective locations in order to determine a state of the reservoir 101, and correspondingly operate the valve assembly (e.g., move the valve sleeve in the open or closed configuration). As will be described further below, the sensors 650 can be configured to communicate with a controller at surface to facilitate the determination of the state of the wellbore, among other properties.

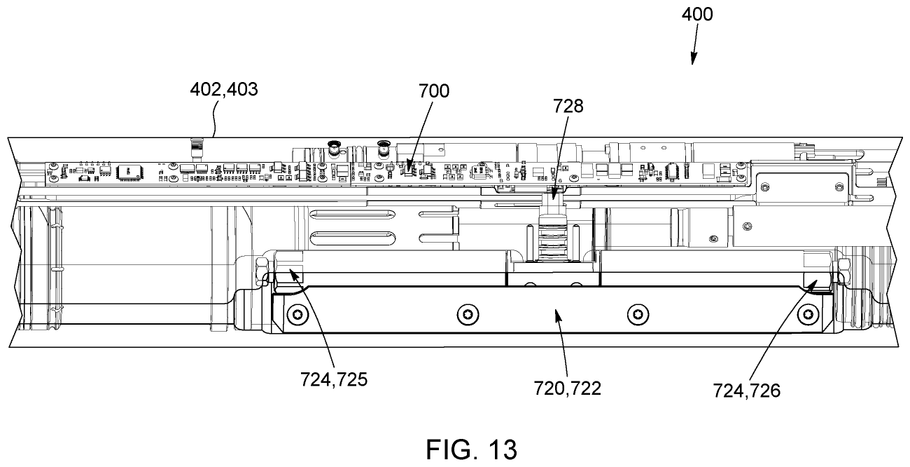

Now referring to FIGS. 13 to 16, the valve assembly 400 can be provided with a control unit 700 disposed within the housing 402 and configured to operate the hydraulic actuator. In this implementation, the control unit 700 can be coupled to a controller at surface (not shown) via a power and communications cable (not shown). The controller is in turn operatively coupled to the valve sleeve 408 (i.e., via the control unit) of each valve assembly 400 and transmits signals thereto to correspondingly open or close the housing outlets. As seen in FIG. 13, the control unit 700 includes a connector for interfacing with the power and communications cable.

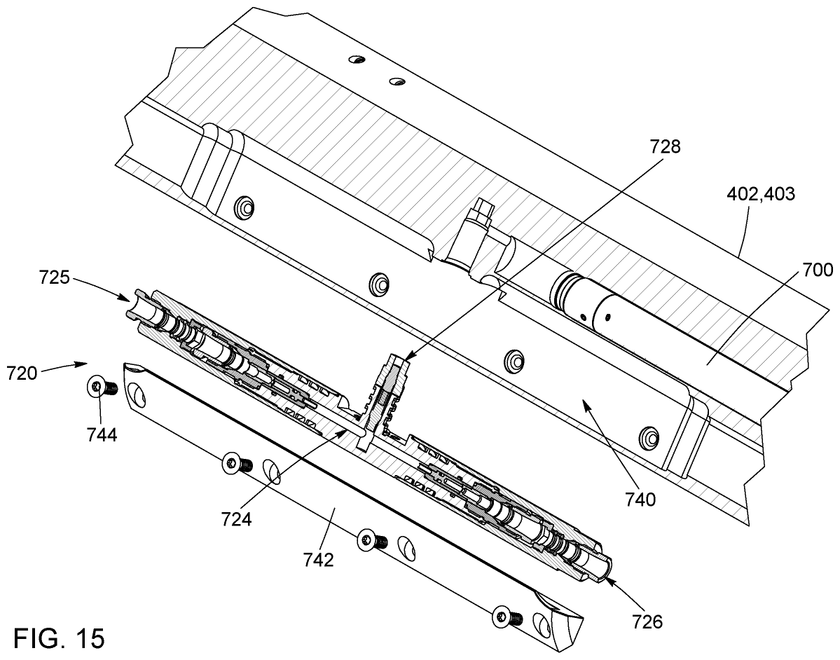

Moreover, the valve assembly 400 can include a coupling assembly 720 for coupling the power and communications cable to the control unit 700. In this implementation, the coupling assembly 720 has a body 722 removably secured to the housing 402 of the valve assembly 400. The body 722 is shaped and configured to receive the power and communications cable, and connect the cable to the control unit 700 within the housing 402. In this implementation, the body 722 includes a lateral connector 724 having a first end 725 and a second end 726 adapted to receive the power and communications cable. It is appreciated that the power and communications cable is adapted to be connected to the lateral connector 724 and extends therefrom for connecting to other various components, such as adjacent coupling assemblies, for example. In this implementation, the cable is spliced (i.e., cut and stripped) prior to being connected to one of the ends. For example, in some implementations, the splice includes a “T splice”, although it is appreciated that other configurations are possible. As will be described further below, and with reference to FIG. 15, the power and communications cable can include a plurality of cable portions having at least one end thereof spliced for connection with a corresponding end of the lateral connector 724. As illustrated, the cable portions can have both ends spliced for connection with a pair of adjacent coupling assemblies 720.

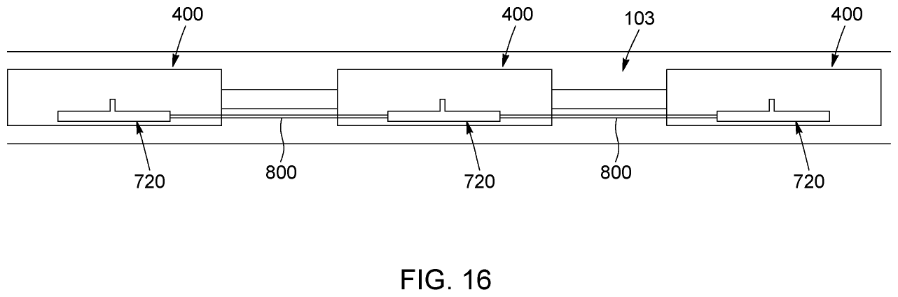

It should be noted that the lateral connectors 724 and cable portions are adapted to operatively connect each coupling assembly together, and thus each valve assembly (i.e., each control unit 700) together. In this implementation, the connection between the lateral connectors can be adapted to connect the valve assemblies in series (as illustrated in FIG. 16) along the wellbore string.

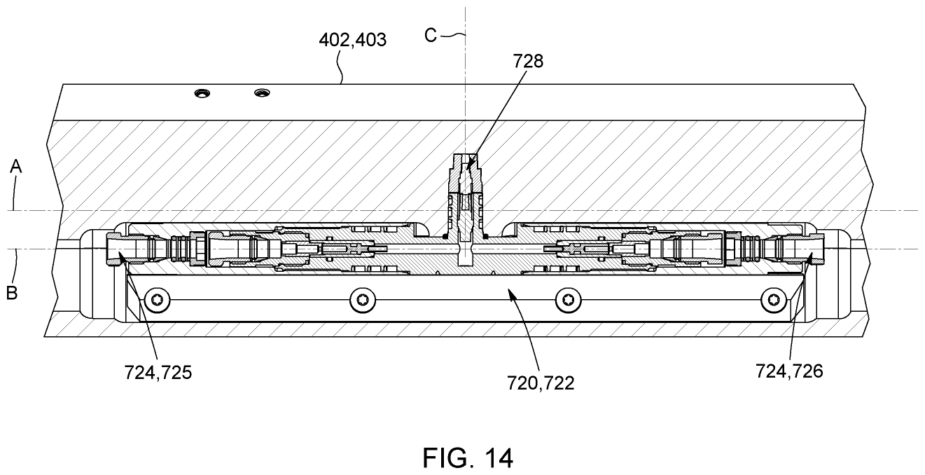

The body of the coupling assembly further includes a connector 728 configured to splice the power and communications cable connected to the lateral connector 724 and provide a connection for interfacing with the control unit 700 (e.g., with the connector of the control unit). As seen in FIGS. 13 to 16, the connector 728 and lateral connector 724 are perpendicularly disposed relative to one another such that the connector 728 can be inserted (i.e., “plugged”) into the valve housing 402, with the lateral connector 724 extending parallel along a length of the housing. In other words, and as seen in FIG. 14, the lateral connector can include a longitudinal axis (B) extending parallel to the longitudinal axis of the valve housing (A) and perpendicular to a longitudinal axis of the connector (C). Therefore, the coupling assembly 720 is configured to enable a connected configuration to the valve assembly, although it is appreciated that other configurations are possible for connecting the coupling assembly and/or providing an electrical connection to the control unit 700.

Moreover, it should be noted that the coupling assembly 720 and valve housing 402 can be cooperatively shaped such that the coupling assembly 720, when coupled to the housing, is contained within an outer diameter of the housing. In other words, the housing 402 has a recessed portion 740 shaped and configured to receive the coupling assembly 720 in a manner such that the coupling assembly 720 does not extend radially from the valve housing 402 and therefore does not impede installation of the valve assembly and/or the wellbore string (e.g., running the wellbore string downhole). In this implementation, the coupling assembly 720 can be secured to the housing 402 once connected to the control unit 700. As seen in FIG. 15, the coupling assembly 720 can include a shell portion 742 shaped and configured to cover the body of the coupling assembly, thereby providing additional protection to the connectors 724, 728 and securing the body 722 relative to the housing 402. In this implementation, the shell portion 742 is connectable to the housing 402 via a plurality of fasteners 744 extending through corresponding holes defined through the shell portion 742 and in the housing 402. As best seen in FIGS. 2 and 3, the valve housing 402 can include a longitudinal passage 730 axially extending along an outer surface of the housing 402 and on either sides of the recessed portion 740. In this implementation, the lateral connector 724 of the coupling assembly 720 aligns with the longitudinal passage 730 such that the power and communications cable is also contained within the outer diameter of the housing once installed and connected.

In some implementations, the coupling assembly 720 can define one or more seals between the wellbore and the housing, and more specifically between the wellbore and the control unit. For example, plugging the coupling assembly into the valve housing can define a seal at the connection interface between the connector of the coupling assembly and the connector of the control unit. Additionally, seals can be defined at each connection point between the power and communications cable and the corresponding end of the lateral connector. In the present implementation, the connection between the coupling assembly and valve housing defines four (4) layers of sealing to prevent fluids from flowing into the valve housing via interstices and potentially damaging components of the control unit. It is appreciated that any suitable type (and amount) of sealing connection can be used, such as, for example, metal-on-metal seals, metal-on-elastomer, elastomer-on-elastomer and/or a combination thereof, among other possibilities.

With reference to FIG. 16, it should be understood that the power and communications cable 800 can extend between two adjacent valve assemblies 400 along the wellbore 103. For example, a section of the power and communications cable can be connected, at a first end thereof, to the first end of the lateral connector of a first valve assembly, and the second end of the cable is connected to the second end of the lateral connector of a second valve assembly. This configuration can repeat between each valve assembly, with the last valve assembly (e.g., the most uphole valve assembly) being connected to the controller at surface.

A method of assembling the valve assembly 400 as described above for installation in a wellbore string will now be described, and more particularly, a method for connecting the coupling assembly to the valve housing, and running the assembled valve assembly downhole with the wellbore string. In this implementation, the method starts with providing a power and communications cable operatively connected to one or more valve assemblies installed in the wellbore string. Then, the cable is severed for defining two separate segments, such as a downhole segment and an uphole segment, with the ends of the segments being stripped and prepared for connection with respective valve assemblies. It should be understood that the downhole segment is operatively connected to the one or more valve assemblies already installed in the wellbore, and that the uphole segment can be connectable to the valve assembly being assembled.

The method then includes attaching the stripped end of the downhole segment to the first end of the lateral connector of a given coupling assembly. Similarly, the method includes attaching the stripped end of the uphole segment to the second end of the lateral connector of that same coupling assembly, therefore providing an electrical connection interface on the coupling assembly. Following the connection of the cable segments to the coupling assembly, the method includes connecting the electrical connection interface to a corresponding interface on a valve assembly to effect an electrical connection between the power and communications cable and the control unit disposed in the valve assembly. In other words, the coupling assembly is “plugged” into the valve assembly housing. It should be understood that the method can further include securing the coupling assembly in place, and finally running the wellbore string (now comprising the assembled valve assembly) downhole. The above-described steps can be repeated for each subsequent valve assembly installed along the wellbore string, therefore defining a multivalve system.

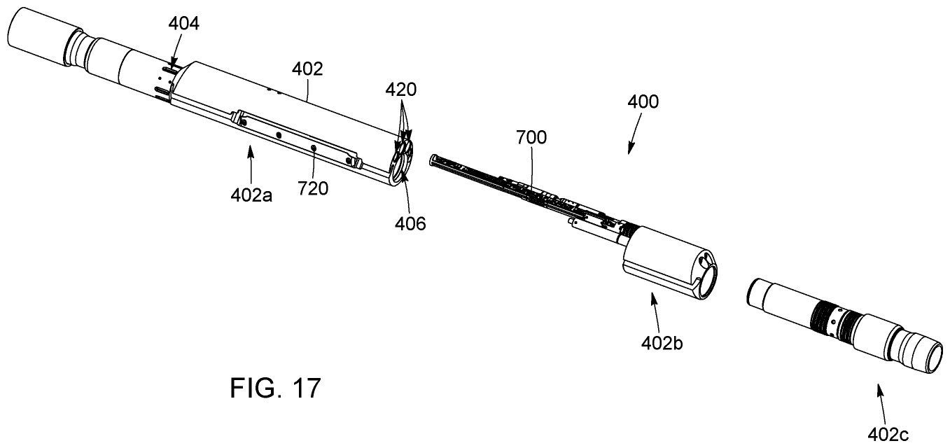

As seen in FIG. 17, in some implementations, the valve assembly 400 can consist of a plurality of components configured to connect to one another to form the valve assembly 400 described above. As illustrated, the valve housing 402 can consist of three (3) sections 402a, 402b, 402c configured to be connected and secured to one another. In this implementation, the first section 402a includes the housing outlet 404 and corresponds to the section of the valve housing 402 which houses the valve sleeve, hydraulic actuator, pressure-compensating system, control unit 700 and the coupling assembly 720. For example, the first section 402a can be provided with a plurality of elongated compartments 420 shaped and sized to house one or more of the aforementioned components. In this implementation, the elongated compartments 420 are defined in the valve housing 402, and more specifically in the first section 402a thereof, and are positioned around the fluid passage 406. Preferably, the elongated compartments 420 are substantially parallel to the fluid passage 406, with one or more of the elongated compartments 420 being fluidly connected, or connectable, with the fluid passage 406, although other configurations are possible.

In this implementation, the second section 402b is configured to be secured to the first section 402a and includes the control unit 700. It should thus be understood that the control unit 700 can be inserted into the corresponding elongated compartment 420 defined within the first section 402a prior to securing the second section 402b to the first. The second section 402b can further include one or more elongated compartments 420 for housing components of the valve assembly, such as the sensors, for example. The third section 402c includes a length of conduit connectable to the second section 402b. The third section 402c can be configured to have conduits (e.g., of the wellbore string) connect thereto, or have the first section 402a of another valve assembly 400 connect thereto, thereby forming the wellbore string.

Referring back to FIGS. 4 to 5A, in some implementations, the displacement of the valve sleeve, relative to the housing, can alternatively, or additionally, be accomplished mechanically, such as via a shifting tool. In those implementations, the valve sleeve 408 is shaped and configured with a complementary profile suitable for mating with the shifting tool. In some implementations, the shifting tool is deployable via the wellbore string for disposition relative to the flow communication station associated with the valve assembly 400, such that the shifting tool becomes disposed for shifting the valve sleeve. In some implementations, deployment of the shifting tool can be done via a conveyance system (e.g. workstring) that is run into the wellbore string. Suitable conveyance systems include a tubing string or wireline, for example. It is appreciated that the valve sleeve, being configured to be mechanically shiftable, can act as a redundancy in case the hydraulic actuator and/or the control unit, and corresponding components, fail or become defective.

Referring back to FIGS. 1 to 2A, in some implementations, the wellbore 103 includes a casing 250 lining an inner surface of the wellbore 103. The casing 250 can be adapted to contribute to the stabilization of the reservoir 101 after the wellbore 103 has been drilled, e.g., by contributing to the prevention of the collapse of the walls of the wellbore 103. In some implementations, the casing 250 includes one or more successively deployed concentric casing strings, each one of which is positioned within the wellbore 103. In some implementations, each casing string includes a plurality of jointed segments of pipe. The jointed segments of pipe typically have threaded connections although other configurations are possible and may be used.

It can be desirable to seal an annulus formed within the wellbore between the casing string 250 and the reservoir 101. Sealing of the annulus can be desirable for preventing injection fluid from flowing into remote zones of the reservoir, thereby providing greater assurance that the injected fluid is directed to the intended zones of the reservoir. To prevent, or at least interfere with injecting fluid into an unintended zone of the reservoir, or to the surface, the annulus can be filled with an isolation material, such as cement, thereby cementing the casing to the reservoir 101. It should be noted that the cement can also provide one or more of the following functions: (a) strengthens and reinforces the structural integrity of the wellbore, (b) prevents, or substantially prevents, produced fluids of one zone from being diluted by water from other zones. (c) mitigates corrosion of the casing 250, and (d) at least contributes to the support of the casing 250.

It is further noted that, the casing 250 includes a plurality of casing outlets 255 for allowing fluid flow from the wellbore string into and from the reservoir (e.g., via injection and production segments respectively). In some implementations, in order to facilitate fluid communication between the wellbore string and the reservoir 101, each one of the casing outlets 255 can be substantially aligned with the housing outlet 404 of a corresponding valve assembly 400. In this respect, in implementations where the wellbore 103 includes the casing 250, injection fluid is injected from the surface down the wellbore string and through the various valve assemblies in order to flow through the housing outlet 404 of the corresponding valve assembly 400 and into an annular space 245 (seen in FIG. 2) defined between certain portions of the wellbore string (e.g., the valve assemblies 400) and the casing string 250, and finally into the reservoir 101 via the casing outlets 255.

The present disclosure may be embodied in other specific forms without departing from the subject matter of the claims. The described example implementations are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the implementations set forth in the examples, but should be given the broadest interpretation consistent with the description as a whole.

As used herein, the terms “coupled”, “coupling”, “attached”, “connected” or variants thereof as used herein can have several different meanings depending in the context in which these terms are used. For example, the terms coupled, coupling, connected or attached can have a mechanical connotation. For example, as used herein, the terms coupled, coupling or attached can indicate that two elements or devices are directly connected to one another or connected to one another through one or more intermediate elements or devices via a mechanical element depending on the particular context.

In the above description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The implementations, geometrical configurations, materials mentioned and/or dimensions shown in the figures are optional, and are given for exemplification purposes only.

In addition, although the optional configurations as illustrated in the accompanying drawings comprises various components and although the optional configurations of the rescue dart as shown may consist of certain geometrical configurations as explained and illustrated herein, not all of these components and geometries are essential and thus should not be taken in their restrictive sense, i.e. should not be taken as to limit the scope of the present disclosure. It is to be understood that other suitable components and cooperations thereinbetween, as well as other suitable geometrical configurations may be used for the implementation and use of the rescue dart, and corresponding parts, as briefly explained and as can be easily inferred herefrom, without departing from the scope of the disclosure.

1-27. (canceled)

28. A valve assembly for disposition within a subterranean reservoir, comprising:
a valve housing comprising a tubular wall defining a fluid passage and having a housing outlet extending through the tubular wall for establishing fluid communication between the fluid passage and the reservoir;
a valve sleeve displaceable between closed and open positions, for controlling the fluid communication between the fluid passage and the reservoir;
a hydraulic actuator operable to displace the valve sleeve, comprising:
a hydraulic fluid container for containing hydraulic fluid; and
a pump operatively connected to the hydraulic fluid container;
a pressure-compensating system operatively connected to the hydraulic actuator and being configured to provide a bi-directional pressure compensation for adjusting fluid pressure within at least one of the valve assembly and the reservoir surrounding the valve assembly.

29. The valve assembly of claim 28, wherein the pressure-compensating system enables injection operations where fluids are injected into the reservoir via the housing outlet, and production operations where fluids are produced from the reservoir via the housing outlet.

30-31. (canceled)

32. A valve assembly for disposition within a subterranean reservoir, comprising:
a housing comprising a tubular wall defining a fluid passage and having a housing outlet extending through the tubular wall for establishing fluid communication between the fluid passage and the reservoir;
a valve sleeve displaceable between closed and open positions, for controlling the fluid communication between the fluid passage and the reservoir;
a hydraulic actuator operable to displace the valve sleeve between the closed and open positions;
a control unit disposed within the housing and configured to operate the hydraulic actuator, the control unit comprising a connector for interfacing with a power and communications cable; and
a coupling assembly for coupling the power and communications cable to the control unit, the coupling assembly having a body removably secured to the housing and comprising:
a lateral connector comprising first and second ends for receiving the power and communications cable therethrough; and
a connector configured to splice the power and communications cable and provide a connection for interfacing with the control unit.

33-35. (canceled)

36. A valve assembly for disposition within a hydrocarbon-containing reservoir, comprising:
a housing comprising a tubular wall defining a central passage and having a housing outlet extending through the tubular wall for establishing fluid communication between the central passage and the reservoir;
a valve sleeve operatively mounted within the housing and being displaceable within the central passage between at least one of a closed configuration for blocking the housing outlet, and an open configuration for allowing fluid communication between the central passage and the reservoir, the valve sleeve having an inner surface facing the central passage and an outer surface facing the tubular wall of the valve housing;
a hydraulic actuator mounted within the housing, comprising:
a hydraulic fluid container containing hydraulic fluid;
a pump operatively connected to the hydraulic fluid container,
the hydraulic actuator being operatively connected to the valve sleeve and adapted to shift the valve sleeve within the housing between the closed and open configurations using hydraulic fluid provided via the pump, the valve sleeve being further shaped and configured to be mechanically shifted using a shifting tool adapted to engage the inner surface of the valve sleeve.

37. (canceled)

38. The valve assembly of claim 28, wherein the pressure-compensating system comprises:
a tubing-pressure compensator fluidly connected to the hydraulic actuator and the fluid passage, the tubing-pressure compensator being configured to adjust a fluid pressure within the fluid passage relative to a fluid pressure of the hydraulic fluid container; and
a reservoir-pressure compensator fluidly connected to the hydraulic actuator and the reservoir, the reservoir-pressure compensator being configured to adjust a fluid pressure of the reservoir surrounding the valve assembly relative to a fluid pressure of the hydraulic fluid container.

39. The valve assembly of claim 38, wherein the tubing-pressure compensator is in fluid communication with the reservoir-pressure compensator via the hydraulic fluid container, and wherein the tubing-pressure compensator and reservoir-pressure compensator are configured to cooperate to adjust the fluid pressure within the fluid passage and the fluid pressure within the reservoir relative to one another.

40. The valve assembly of claim 38, wherein the tubing-pressure compensator comprises a first piston having a first end in fluid communication with the fluid passage, and a second end in fluid communication with the hydraulic fluid container, and wherein the reservoir-pressure compensator comprises a second piston having a first end in fluid communication with the reservoir, and a second end in fluid communication with the hydraulic fluid container, and wherein the first and second pistons are configured to actuate autonomously to adjust the fluid pressures within at least one of the fluid passage and the reservoir.

41. The valve assembly of claim 38, wherein the hydraulic fluid container comprises a first tubular container axially aligned and in fluid communication with the tubing-pressure compensator, and a second tubular container axially aligned and in fluid communication with the reservoir-pressure compensator, the first and second tubular containers being in fluid communication with each other.

42. The valve assembly of claim 28, wherein the hydraulic container and the pump extend axially within the valve housing and are distributed around the fluid passage.

43. The valve assembly of claim 28, wherein the valve sleeve is slidably mounted within the valve housing and slidable between the open and closed positions via actuation of the hydraulic actuator.

44. The valve assembly of claim 28, wherein the valve sleeve is mounted within the fluid passage and defines one or more hydraulic chambers between an outer surface of the valve sleeve and an inner surface of the valve housing, the hydraulic chambers being adapted to receive hydraulic fluid from the hydraulic fluid container via the pump to create a force on the valve sleeve to displace the valve sleeve.

45. The valve assembly of claim 28, further comprising a tubing-pressure sensor in fluid pressure communication with the fluid passage and configured to measure the fluid pressure within the fluid passage, and a reservoir-pressure sensor in fluid pressure communication with the reservoir configured to measure the fluid pressure within the reservoir surrounding the valve assembly, and wherein the tubing-pressure sensor and reservoir-pressure sensor extend axially within the valve housing and are distributed around the fluid passage.

46. The valve assembly of claim 28, further comprising a control unit disposed within the valve housing and configured to operate the hydraulic actuator, the control unit comprising a connector for interfacing with a power and communications cable.

47. The valve assembly of claim 46, wherein the control unit extends axially within the valve housing and is radially spaced from the fluid passage.

48. The valve assembly of claim 47, further comprising a coupling assembly having a body removably secured to the valve housing and being adapted for coupling the power and communications cable to the control unit.

49. The valve assembly of claim 48, wherein the coupling assembly comprises a lateral connector for receiving the power and communications cable, and a transversal connector extending from the lateral connector and being configured to splice the power and communications cable and provide a connection for interfacing with the connector of the control unit.

50. The valve assembly of claim 49, wherein the valve housing comprises a recessed portion shaped and configured to receive the body of the coupling assembly, and wherein the coupling assembly is radially contained within an outer diameter of the valve housing.

51. The valve assembly of claim 50, wherein the valve housing comprises a longitudinal passage extending axially along an outer surface of the valve housing and on either sides of the recessed portion, and wherein the lateral connector is adapted to axially align with the longitudinal passage such that the power and communications cable is radially contained within the outer diameter of the valve housing.

52. The valve assembly of claim 47, wherein the valve assembly is operatively connectable to other valve assemblies deployed along the wellbore via the power and communications cable.

53. The valve assembly of claim 38, wherein the valve housing comprises at least two valve housing sections connectable to one another, and wherein a first valve housing section comprises axially extending channels defined in a thickness of the tubular wall and are distributed around the fluid passage, the axially extending channels being configured to house the tubing-pressure compensator, the reservoir-pressure compensator, the hydraulic fluid container and the pump.
